(19) United States
(12) Patent Application Publication
(10) Pub. No.: US 2012/0133820 A1
(43) Pub. Date: May 31, 2012

(54) AUTOFOCUS METHOD AND AN IMAGE CAPTURING SYSTEM

(75) Inventor: SHENG-HSIUNG HSU, Changhua County (TW)

(73) Assignee: ABILITY ENTERPRISE CO., LTD., TAIPEI (TW)

(21) Appl. No.: 13/174,566

(22) Filed: Jun. 30, 2011

(30) Foreign Application Priority Data
Nov. 30, 2010 (TW) 099141411

(51) Int. Cl. H04N 5/232

(52) U.S. Cl. 348/345; 348/E05.045

(57) ABSTRACT

The present invention is directed to an autofocus method and an image capturing system. A focusing lens is used to focus within a first moving interval in a zoom mode, and a plurality of first focusing positions and a plurality of corresponding first focusing data are recorded. An absolute maximum is determined among the first focusing data. A second moving interval is determined if the absolute maximum does not exist among the first focusing data, and the focusing lens is used to focus within the second moving interval to obtain a plurality of second focusing data. The absolute maximum is determined according to the second focusing data, wherein a second focusing position corresponding to the absolute maximum is an autofocus position.

### CROSS-REFERENCE TO RELATED APPLICATIONS

The entire contents of Taiwan Patent Application No. 099141411, filed on Nov. 30, 2010, from which this application claims priority, are incorporated herein by reference.

### BACKGROUND OF THE INVENTION

1. Field of the Invention

The present invention generally relates to imaging techniques, and more particularly to an autofocus method for an image capturing system.

2. Description of Related Art

The focusing lens of a camera typically needs to be calibrated with respect to what is referred to as an infinity focusing position, with the calibrated infinity focusing position being recorded in a memory device of the camera before departure of the camera from the factory. Later, when a user of the camera pushes the shutter button halfway down, the focusing lens will be moved according to the stored infinity focusing position in order to carry out the focusing.

However, the position of the focusing lens may be shifted due to external environmental changes such as temperature or humidity changes, or owing to external forces such as may occur as a consequence of a fall or a particular placing position. As a result, the actual infinity focusing position can be different from the calibrated value stored before the camera left the factory, whereby the focusing lens therefore cannot move to a correct focusing position with blurred images thus being captured as a result of the camera being out of focus. The situation becomes worse if a plastic lens is used. The plastic material is liable to absorb vapor, which incurs a change in the refractive index of the focusing lens. Moreover, the refractive index of the focusing lens may be altered with external temperature and humidity leading to expanding or shrinking of the focusing lens.

For the foregoing reasons, a need has arisen to propose a novel autofocus method to improve the out-of-focus problems mentioned above.

### SUMMARY OF THE INVENTION

In view of the foregoing, it is an object of the embodiment of the present invention to provide an autofocus method and an image capturing system to compensate for focus position shifting caused by an external environment condition, such that a correct autofocus may be achieved.

According to one embodiment of the present invention, focusing lens is used to focus within a first moving interval in a zoom mode, and a plurality of first focusing positions and a plurality of corresponding first focusing data are recorded. An absolute maximum is determined among the first focusing data. A second moving interval is determined if the absolute maximum does not exist among the first focusing data, and the focusing lens is used to focus within the second moving interval to obtain, a plurality of second focusing data. The absolute maximum is determined according to the second focusing data, wherein a second focusing position corresponding to the absolute maximum is an autofocus position.

According to another embodiment of the present invention, the image capturing system includes a focusing lens group, an actuator, a storage device and a central processor. The actuator is configured to drive the focusing lens group to a plurality of first focusing positions within a first moving interval in a zoom mode. The storage device is configured to record the first focusing positions and a plurality of corresponding first focusing data. The central processor is configured to determine an absolute maximum among the first focusing data. The central processor determines a second moving interval if the absolute maximum does not exist among the first focusing data; the focusing lens group is driven by the actuator within the second moving interval to obtain a plurality of second focusing data; and the central processor determines the absolute maximum according to the second focusing data, a second focusing position corresponding to the absolute maximum being an autofocus position.

### BRIEF DESCRIPTION OF THE DRAWINGS

FIG. 1 shows a block diagram of an image capturing system.

according to one embodiment of the present invention;

FIG. 2 shows a flow diagram of an autofocus method according to one embodiment of the present invention; and

FIG. 3A to FIG. 3C show exemplary edge curves.

### DETAILED DESCRIPTION OF THE INVENTION

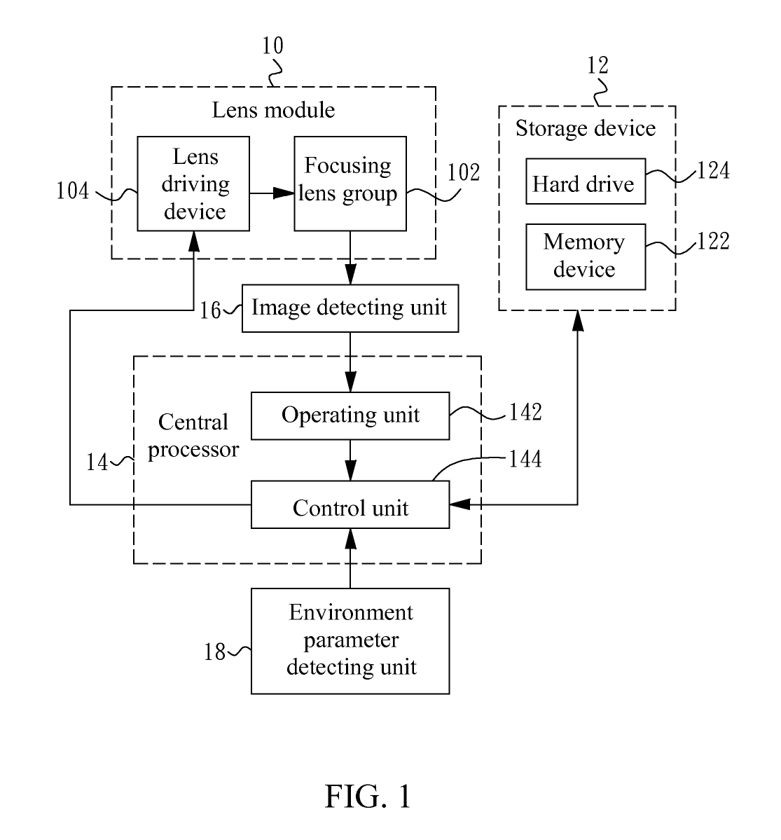

FIG. 1 shows a block diagram of an image capturing system.

according to one embodiment of the present invention. The image capturing system of the embodiment is primarily used to perform.

autofocus. The image capturing system may be adapted to, but not limited to, a camera, a video recorder, a mobile phone, a personal digital assistant, a digital music player or a webcam. In the embodiment, the image capturing system primarily includes a lens module 10, a storage device 12 and a central processor 14. The image capturing system may further include an image detecting unit 16 and an environment parameter detecting unit 18.

Referring to FIG. 1, the lens module 10 of the present invention includes a focusing lens group 102 and a lens driving device 104. Specifically, the focusing lens group 102 may be used to focus an object within a predetermined moving interval. The focusing lens group 102 may include at least one focusing lens. The lens driving device 104 is controlled by the central processor 14 to drive the focusing lens of the focusing lens group 102 to a plurality of focusing positions. The lens driving device 104 may include an actuator such as, but not limited to, a step motor. It is noted that, in the specification, the “focusing lens group 102” and the “focusing lens” that are driven, by the lens driving device 104 may be used interchangeably to mean that the lens driving device 104 may either drive the at least one focusing lens or drive the entire focusing lens group 102.

Still referring to FIG. 1, the image captured by the lens module 10 is converted, from an analog light, signal to a digital electrical signal by the image detecting unit 16. The electrical signal includes a plurality of focusing data, such as edge sharpness values, obtained by the lens module 10. Subsequently, the focusing data are fed to and operated by the central processor 14. The central processor 14 of the embodiment includes an operating unit 142 and a control unit 144. Specifically speaking, the operating unit 142 performs mathematical operations on the focusing data, and the control unit 144 controls the lens driving device 104 according to the results of the mathematical operations to move the focusing lens group 102 in order to obtain an autofocus position. The operating unit 142 of the embodiment may be a digital signal processor, and the control unit 144 may be a central processing unit. For example, the central processor 14 is made in a chip, and the operating unit 142 and the control unit 144 are integrated in the chip.

Still referring to FIG. 1, the storage device 12 is primarily used to record the focusing position and the corresponding focusing data. The storage device 12 of the embodiment includes a built-in memory device 122 as a primary memory and a hard drive 124 as a secondary memory. Further, the storage device 12 may be used to store infinity focusing position. In one embodiment, the storage device 12 stores an actuating step adjusting table for the lens driving device 104. The actuating step adjusting table records actuating step adjusting rates corresponding to various environment parameters for several zoom modes, where the environment parameter may be, but not limited to, temperature or humidity. Table 1 exemplifies an actuating step adjusting table, in which the temperature is used as the environment parameter. According to the embodiment, if the infinity focusing position for a wide-angle mode is at a position of 200 steps at 25° C., the infinity focusing position should be at a position of 150 steps at 0° C., that is, 200−10*((25−0)/5). In one embodiment, the central processor 14 may update the adjusted infinity focusing position in the storage device 12. The temperature change mentioned above may be provided by the environment parameter detecting unit 18.

TABLE 1

| | Temperature change | Actuating step adjusting |
|---|---|---|
| Zoom mode | rate (° C.) | rate (step) |
| (wide angle) | +5 | +10 |
| Z₀ | −5 | −10 |
| Z₁ | +5 | +15 |
| | −5 | −15 |
| Z₂ | +5 | +20 |
| | −5 | −20 |
| (telephoto) | +5 | +25 |
| Z₃ | −5 | −25 |

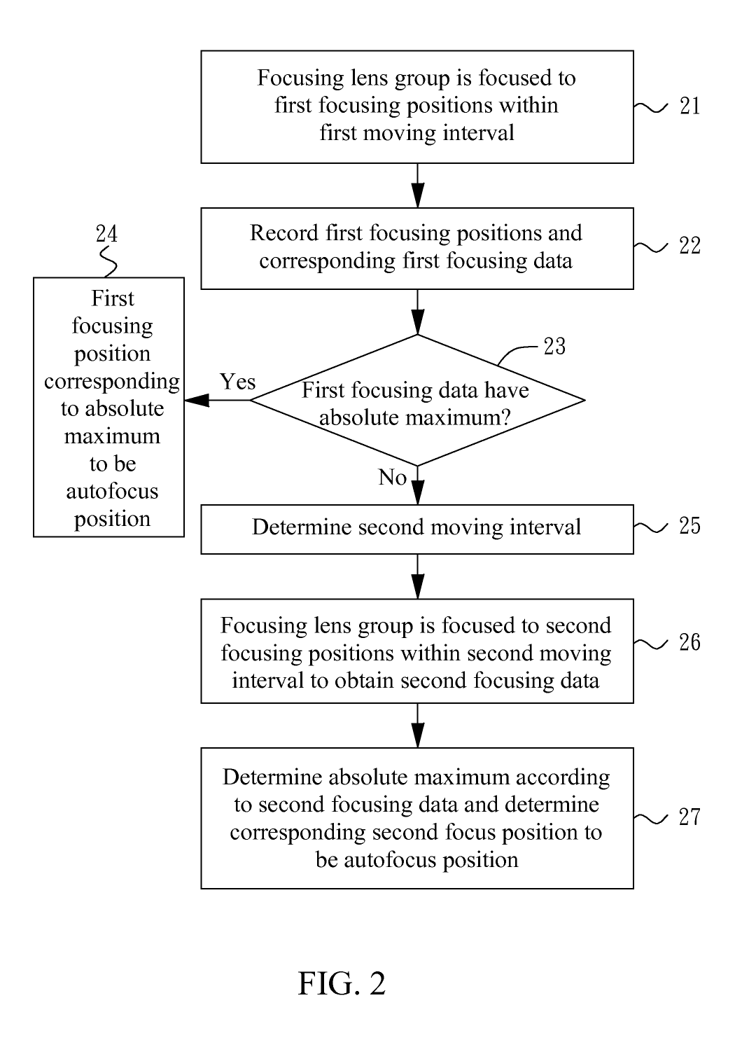

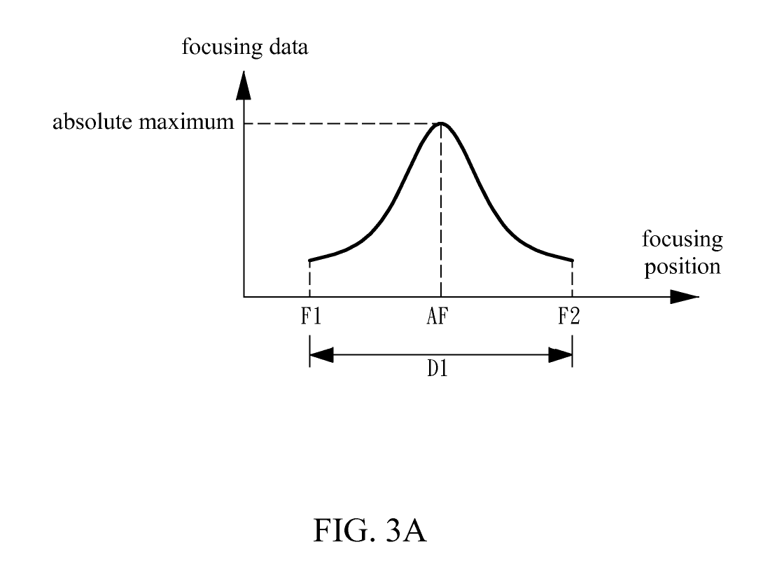

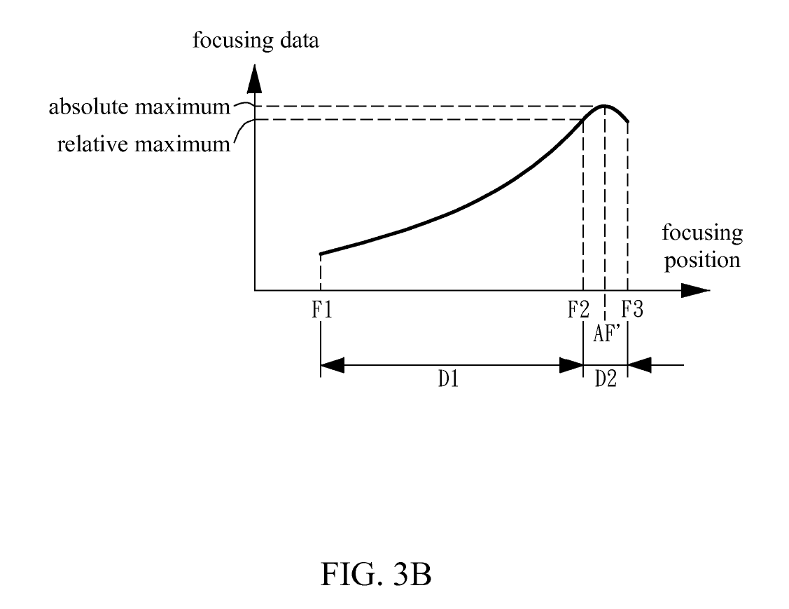

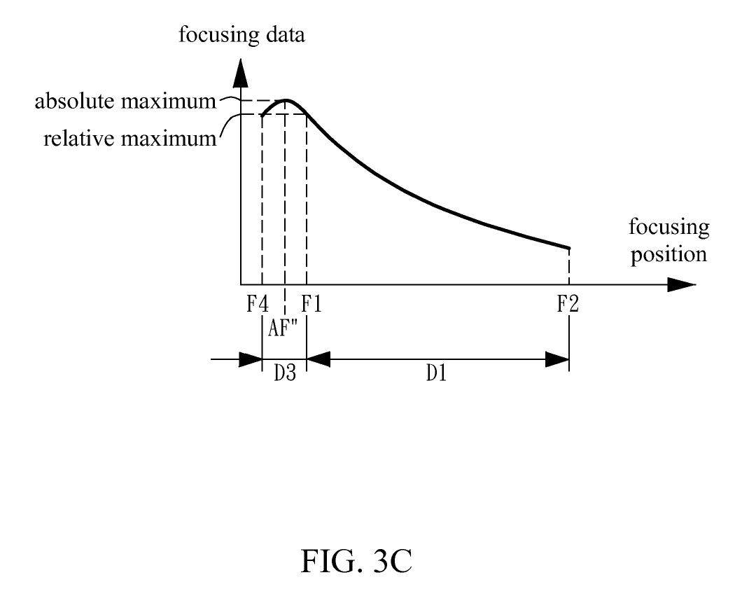

FIG. 2 shows a flow diagram of an autofocus method according to one embodiment of the present invention. The autofocus method may be adapted to the image capturing system as shown in FIG. 1. Referring to FIG. 1 and FIG. 2, in step 21, the focusing lens group 102 is used to focus to a plurality of first focusing positions within a first moving interval in a zoom mode. As described above, the focusing lens group 102 may be driven to the first focusing positions by the actuator of the lens driving device 104. A digital camera, for example, has various zoom modes such as a normal zoom mode and a close-up zoom mode, where the normal zoom mode has a range from infinity to 80 cm, and the close-up zoom mode has a range between 80 cm and 10 cm. Subsequently, in step 22, the storage device 12 records the first focusing positions and the corresponding first focusing data. In the embodiment, the first focusing data are edge sharpness values. The first focusing positions and the first focusing data mentioned above form an edge curve. FIG. 3A shows an exemplary edge curve with a vertical axis representing the focusing data and a horizontal axis representing the focusing position. In this example, the first moving interval D1 is located between a first predetermined position F1 and a second predetermined position F2. The first predetermined position F1 may be the infinity focusing position, which may be stored in the storage device 12.

Still referring to FIG. 1, FIG. 2 and FIG. 3A, in step 23, the central processor 14 determines whether the first focusing data of the edge curve have an absolute maximum. In the embodiment, values preceding and succeeding the ‘absolute maximum.’ are smaller than the absolute maximum. If the absolute maximum exists in step 23, proceed to step 24, in which the first focusing position corresponding to the absolute maximum is determined as the autofocus position. As exemplified in the edge curve of FIG. 3A, the central processor 14 determines that the absolute maximum exists at the first focusing position AF, which is defined as the autofocus position, according to the slope of the edge curve or according to preceding and succeeding values at the first focusing position.

Referring to FIG. 1 and FIG. 2, if the absolute maximum does not exist in step 23, proceed to step 25, in which the central processor 14 determines a second moving interval according to the edge curve. Subsequently, in step 26, the central processor 14 controls the actuator of the lens driving device 104 to move the focusing lens group 102 to a plurality of second focusing positions within, the second moving interval, thereby obtaining a plurality of corresponding second focusing data. Similar to the first focusing data, the second focusing data may be edge sharpness values. Finally, in step 27, the central processor 14 determines the absolute maximum according to the slope or the value of the second focusing data, and the second focusing position corresponding to the absolute maximum is determined as the autofocus position.

FIG. 3B shows another exemplary edge curve. Regarding this edge curve, the first focusing data corresponding to the second predetermined position F2 is not the absolute maximum with respect to the first moving interval D1 but a relative maximum, which may be determined by the central processor 14 according to the slope or value of the edge curve. Subsequently, in step 25, the second moving interval D2 is obtained, by extending outward from the second predetermined position F2 to a third predetermined position F3, thereby obtaining the second moving interval D2 located between the second predetermined position F2 and the third predetermined position F3. Alternatively, the second moving interval D2 may extend from the third predetermined position F3 toward the second predetermined position F2 and further to a specific position, such as F1, preceding the second predetermined position F2. In summary, the second moving interval D2 may be located between the second predetermined position F2 and the third predetermined position F3; or may be located between a specific position and the third predetermined position F3 to include the second predetermined position F2. Referring to FIG. 1 and FIG. 2, the third predetermined position F3 may be obtained by the central processor 14 according to extrapolation on the edge curve, or may be pre-stored as a predetermined, distance in the storage device 12. The specific position mentioned above may be a predetermined distance when the focusing lens group 102 is moved by the lens driving device 104 from the second predetermined position F2 toward the first predetermined position F1. For example, if a step motor is used as the lens driving device 104, the specific position is the predetermined steps when the step motor moves from the second predetermined position F2 toward the first predetermined position F1. In the embodiment, the second moving interval D2 is located between the second predetermined position F2 and the third predetermined position F3.

Still referring to FIG. 1 and FIG. 2, in step 26, the focusing lens group 102 is moved within the second moving interval D2 to obtain the second focusing data. Finally, in step 27, the absolute maximum in the second moving interval D2 is determined, and the second focusing position AF′ corresponding to the absolute maximum is determined as the autofocus position. As exemplified in the edge curve of FIG. 3B, the central processor 14 determines that the absolute maximum exists at the second focusing position. AF′, which is then defined as the autofocus position.

FIG. 3C shows a further exemplary edge curve. Regarding this edge curve, the first focusing data corresponding to the first predetermined position F1 is not the absolute maximum with respect to the first moving interval D1 but a relative maximum, which may be determined by the central processor 14 according to the slope or value of the edge curve. Subsequently, in step 25, the second moving interval D3 is obtained by extending outward from the first predetermined position F1 to a fourth predetermined position F4, thereby obtaining the second moving interval D3 located, between the first predetermined position F1 and the fourth predetermined position F4. Alternatively, the second moving interval D3 may extend from the fourth predetermined position F4 toward the first predetermined, position F1 and further to a specific position, such as F2, succeeding the first predetermined position F1. In summary, the second moving interval D3 may be located between the first predetermined position F1 and the fourth predetermined position F4; or may be located between a specific position and the fourth predetermined position F4 to include the first predetermined position F1. In the embodiment, the second moving interval D3 is located between the first predetermined position F1 and the fourth predetermined position F4. Subsequently, in step 26, the focusing lens group 102 is moved within the second moving interval D3 to obtain the second focusing data. Finally, in step 27, the absolute maximum in the second moving interval D3 is determined, and the second focusing position AF″ corresponding to the absolute maximum is determined, as the autofocus position. As exemplified in the edge curve of FIG. 3C, the central processor 14 determines that the absolute maximum exists at the second focusing position AF″, which is then defined as the autofocus position.

Referring to FIG. 1, FIG. 3B, FIG. 3C and Table 1, in one embodiment, the central processor 14 may change the actuating step adjusting rate of the lens driving device 104 according to the zoom mode and the current environment parameter, such as temperature or humidity. Moreover, the central processor 14 may change the third predetermined position F3 and the fourth predetermined position F4 according to the actuating step adjusting table as exemplified in Table 1. In another embodiment, the central processor 14 may update the infinity focusing position according to the fourth predetermined position F4, and the storage device 12 may update the actuating step adjusting table as exemplified in Table 1 according to the fourth predetermined position F4. It is appreciated that a person skilled in the pertinent art may revise another actuating step adjusting table or replace with an actuating step adjusting table according to other environment parameters.

Although specific embodiments have been illustrated and described, it will be appreciated by those skilled in the art that various modifications may be made without departing from the scope of the present invention, which is intended to be limited solely by the appended claims.

What is claimed is:

1. An autofocus method, comprising:
focusing within a first moving interval in a zoom mode by a focusing lens;
recording a plurality of first focusing positions and a plurality of corresponding first focusing data;
determining an absolute maximum among the first focusing data;
determining a second moving interval if the absolute maximum does not exist among the first focusing data;
focusing within the second moving interval by the focusing lens to obtain a plurality of second focusing data; and
determining the absolute maximum according to the second focusing data, wherein a second focusing position corresponding to the absolute maximum is an autofocus position.

2. The method of claim 1, further comprising:
determining the first focusing position corresponding to the absolute maximum as the autofocus position when the absolute maximum exists among the first focusing data.

3. The method of claim 1, wherein the first focusing data are edge sharpness values.

4. The method of claim 1, wherein, the second focusing data are edge sharpness values.

5. The method of claim 1, wherein the first moving interval is located between a first predetermined position and a second predetermined position, wherein, the second moving interval extends outward from the second predetermined position to a third predetermined position when the first focusing data corresponding to the second predetermined position is a relative maximum among the first focusing data, or extends from the first predetermined position toward the second predetermined position and further to the third predetermined, position when the first focusing data corresponding to the second predetermined position is a relative maximum among the first focusing data.

6. The method of claim 5, wherein the second moving interval extends outward from the first predetermined position to a fourth predetermined position when the first focusing data corresponding to the first predetermined, position is a relative maximum among the first focusing data, or extends from the second predetermined position toward the first predetermined position and further to the fourth predetermined position when the first focusing data corresponding to the first predetermined position is a relative maximum among the first focusing data.

7. The method of claim 6, wherein the first predetermined position is infinity focusing position.

8. The method of claim 7, further comprising:
providing an actuating step adjusting table, based on which an actuating step adjusting rate is determined according to the zoom mode and an environment parameter.

9. The method of claim 8, wherein the third predetermined position and the fourth predetermined, position are adjusted based on the actuating step adjusting table.

10. The method of claim 8, further comprising:
updating the infinity focusing position and the actuating step adjusting table according to the fourth predetermined position.

11. An image capturing system, comprising:
a focusing lens group;
an actuator configured to drive the focusing lens group to a plurality of first focusing positions within a first moving interval in a zoom mode;
a storage device configured to record the first focusing positions and a plurality of corresponding first focusing data; and
a central processor configured to determine an absolute maximum among the first focusing data;
wherein the central processor determines a second moving interval if the absolute maximum does not exist among the first focusing data;
wherein the focusing lens group is driven by the actuator within the second moving interval to obtain a plurality of second focusing data; and
wherein the central processor determines the absolute maximum according to the second focusing data, a second focusing position corresponding to the absolute maximum being an autofocus position.

12. The image capturing system of claim 11, wherein the central processor further determines the first focusing position corresponding to the absolute maximum as the autofocus position when the absolute maximum exists among the first focusing data.

13. The image capturing system of claim 11, wherein the first focusing data are edge sharpness values.

14. The image capturing system of claim 11, wherein the second focusing data are edge sharpness values.

15. The image capturing system of claim 11, wherein the first moving interval is located between a first predetermined position and a second predetermined position, wherein, the central processor determines the second moving interval extends outward from the second predetermined position to a third predetermined position when the first focusing data corresponding to the second predetermined position is a relative maximum among the first focusing data, or extends from the first predetermined position toward the second predetermined position and further to the third predetermined position when the first focusing data corresponding to the second predetermined position is a relative maximum among the first focusing data.

16. The image capturing system of claim 15, wherein the central processor determines the second moving interval extends outward from the first predetermined, position to a fourth predetermined position when the first focusing data corresponding to the first predetermined position is a relative maximum among the first focusing data, or extends from the second predetermined position toward the first predetermined position and further to the fourth predetermined position when the first focusing data corresponding to the first predetermined position is a relative maximum among the first focusing data.

17. The image capturing system of claim 16, wherein the first predetermined position is infinity focusing position stored in the storage device.

18. The image capturing system of claim 17, wherein the storage device stores therein an actuating step adjusting table, based on which an actuating step adjusting rate is determined according to the zoom mode and an environment parameter.

19. The image capturing system of claim 18, wherein the central processor adjusts the third predetermined position and the fourth predetermined position based on the actuating step adjusting table.

20. The image capturing system of claim 18, wherein the central processor updates the infinity focusing position according to the fourth predetermined position, and the storage device updates the actuating step adjusting table according to the fourth predetermined position.
